(19) United States
(12) Patent Application Publication
(10) Pub. No.: US 2020/0062562 A1
(43) Pub. Date: Feb. 27, 2020

(54) A MECHANISM FOR A SCISSOR LIFT OR A TILT SYSTEM

(71) Applicant: GLOBAL FABTECH (SHANGHAI) COMPANY LIMITED, Jiuting, Songjiang District (CN)

(72) Inventor: Hans Balle CHRISTENSEN, Herning (DK)

(21) Appl. No.: 16/463,314

(22) PCT Filed: Nov. 21, 2017
(86) PCT No.: PCT/IB2017/057292

§ 371 Date: May 22, 2019

(30) Foreign Application Priority Data
Nov. 23, 2016 (DK) PA201670931

(51) Int. Cl. B66F 7/06; B66F 7/08

(52) U.S. Cl. CPC B66F 7/0683; A61G 5/1059; B66F 7/08

(57) ABSTRACT

A mechanism for a scissor lift (1) or for a tilt system (21) is disclosed, which mechanism comprises a lower frame (2), an upper frame (3), a controlling arm (6), a lifting arm (7) and a power source (8) and is configured in such a way that an extension of the length of the power source (8) causes the lifting arm (7) to pull a fulcrum (14) on the first lever arm (4) or a fulcrum (22) on the second lever arm (5) in a direction away from the lower frame (2), which, in turn, causes the lowermost end of the second lever arm (5) to be pulled towards the lowermost end of the first lever arm (4) and at least one end of the upper frame (3) to be forced away from the lower frame (2). The power source (8) will provide a substantially constant power throughout the motion when the mechanism being used in a scissor lift, whereas, the power source (8) may give maximum power in the beginning of the motion and less power later on in a tilt system. Furthermore, a scissor lift (1) and a tilt system (21) each comprising such a mechanism and a wheel chair comprising such a scissor lift and/or such a tilt system are disclosed.

The present invention relates to a mechanism for a lifting device or for a tilt system, for instance to be mounted in an electric wheel chair for adjustment of the height or the inclination of the seat thereof, respectively.

### BACKGROUND OF THE INVENTION

The use of lifting devices in tables, chairs and beds, etc. is well-known. The majority of such lifting devices operate according to the so-called “scissor principle”, in which a lower frame and an upper frame are connected by two lever arms pivotally connected in a configuration similar to the one of the two arms in a pair of scissors. Most often, there are two pairs of such “scissored” lever arms arranged in two opposite sides of the lifting device, respectively.

At their top and bottom ends, these lever arms are connected to the upper and the lower frames, respectively, in such a way that, when the two ends of a pair of lever arms connected to the same frame are moved towards each other, the distance between the two frames is increased. Similarly, when the two ends of the pair of lever arms connected to the same frame are moved away from each other, the distance between the two frames is decreased. The movements of the lever arms can be affected by an actuator such as, for instance, a hydraulic or an electric linear actuator.

Although this lifting principle functions very well and provides many good solutions for lifting devices, however, actuators used in such scissor lifts, and in tilt systems which may be constructed using similar principles, must typically be somewhat oversized in order to deliver the required force. This is because, especially in the innermost and outermost positions of the scissor lift, the actuator force is not utilized effectively in such known scissor lift configurations. Furthermore, it is difficult to fit in scissor lifts and tilt systems known in the art in many applications, such as for instance wheel chairs, because the available space is relatively small compared to the required power of the scissor lifts and/or tilt systems.

### BRIEF DESCRIPTION OF THE INVENTION

It is an object of the invention to provide a mechanism for a scissor lift or a tilt system that overcomes at least partly the above-mentioned disadvantages of such mechanisms known in the art.

The present invention relates to a mechanism for a scissor lift or for a tilt system, which mechanism comprises a lower frame and an upper frame, which are connected by at least one pair of lever arms rotatably connected to each other in a pivotal point, wherein, at least in a contracted configuration of the mechanism, the lower frame and the upper frame are substantially parallel to each other, wherein a first lever arm is rotatably connected at its lowermost end to the lower frame in a fulcrum and the second lever arm is connected at its uppermost end to the upper frame and in sliding engagement with the lower frame at its lowermost end in such a way that, when the lowermost end of the second lever arm is moved towards the lowermost end of the first lever arm, at least the end of the upper frame, to which the uppermost end of the second lever arm is connected, is forced away from the lower frame, and wherein the mechanism further comprises a controlling arm rotatably connected at its lowermost end to the lower frame in a fulcrum and rotatably connected at its uppermost end to a first end of a lifting arm in a fulcrum, which lifting arm at its other end is a rotatably connected to the first lever arm in a fulcrum or to the second lever arm in a fulcrum, and a power source, such as a linear actuator, rotatably connected at its lowermost end to the lower frame in a fulcrum and rotatably connected at its uppermost end to the controlling arm and/or the lifting arm in a fulcrum, in such a way that an extension of the length of the power source causes the lifting arm to pull the fulcrum on the first lever arm in a direction away from the lower frame, which, in turn, causes the lowermost end of the second lever arm to be pulled towards the lowermost end of the first lever arm.

In an embodiment of the invention, the controlling arm and/or the lifting arm is provided with a plurality of attachment points, potentially arranged on one or more flanges extending from the controlling arm and/or the lifting arm, each of which attachment points can be used as fulcrums for connection of the uppermost end of the controlling arm, the first end of the lifting arm and the uppermost end of the power source to each other.

In an embodiment of the invention, the controlling arm, the lifting arm and the power source are all connected in a common fulcrum.

Thus, in contrast to similar mechanisms known in the art, in which the uppermost end of the first lever arm is caused to rotate away from the lower frame by pushing a point on the first lever arm in an upward direction, this motion of the first lever arm in the present invention is caused by pulling a point on the first lever arm in an upward direction. This feature in combination with the possibility to choose between a plurality of different fulcrums for the uppermost end of the power source gives a large variety of adjustment possibility for the power utilisation and stroke length of the power source. For instance, in one position of the fulcrum for the uppermost end of the power source, the power source will provide a substantially constant power throughout the motion, which optimises the mechanism for being used in a scissor lift, whereas, in another position of the fulcrum, the power source may give maximum power in the beginning of the motion and less power later on, which is the optimal solution for a tilt system.

In an embodiment of the invention, the sliding engagement between the second lever arm and the lower frame is obtained by means of a roller or a slider suspended in a suspension point at the lowermost end of the second lever arm.

In an embodiment of the invention, the first lever arm is in sliding engagement with the upper frame at its uppermost end.

In an embodiment of the invention, the sliding engagement between the first lever arm and the upper frame is obtained by means of a roller or a slider suspended in a suspension point at the uppermost end of the first lever arm.

In an aspect of the invention, it relates to a scissor lift comprising a mechanism as described above.

In an embodiment of the invention, the scissor lift is able to lift a load of at least 180 kg, preferably at least 250 kg.

In an embodiment of the invention, the scissor lift is able to lift a load over a range of at least 250 mm, preferably at least 300 mm.

In an embodiment of the invention, the height of the scissor lift in a fully collapsed configuration is less than 125 mm, preferably less than 90 mm.

A lifting device with such characteristics is very suitable for being used in applications with demand for a high lifting capacity like, for instance, as a built-in seat hoist in a wheel chair.

In an aspect of the invention, it relates to a tilt system comprising a mechanism as described above.

In an embodiment of the invention, the tilt system is able to tilt the upper frame in an angle of at least 40°, preferably at least 60°, compared to the lower frame.

In an aspect of the invention, it relates to a wheel chair with a built-in seat hoist comprising a scissor lift as described above and/or a tilt system as described above.

### THE DRAWINGS

In the following, a few exemplary embodiments of the inventions are described in more detail with reference to the drawings, of which

FIG. 1a is a principle sketch of a scissor lift according to an embodiment of the invention in a fully collapsed configuration,

FIG. 1b is a principle sketch of the same scissor lift in a partly unfolded configuration,

FIG. 1c is a principle sketch of the same scissor lift in a fully unfolded configuration,

FIG. 2a is a principle sketch of a tilt system according to an embodiment of the invention in an untilted configuration,

FIG. 2b is a principle sketch of the same tilt system in a fully tilted configuration,

FIG. 3a is a principle sketch of a scissor lift according to another embodiment of the invention in a fully collapsed configuration, and

FIG. 3b is a principle sketch of the same scissor lift in a fully unfolded configuration.

### DETAILED DESCRIPTION OF THE INVENTION

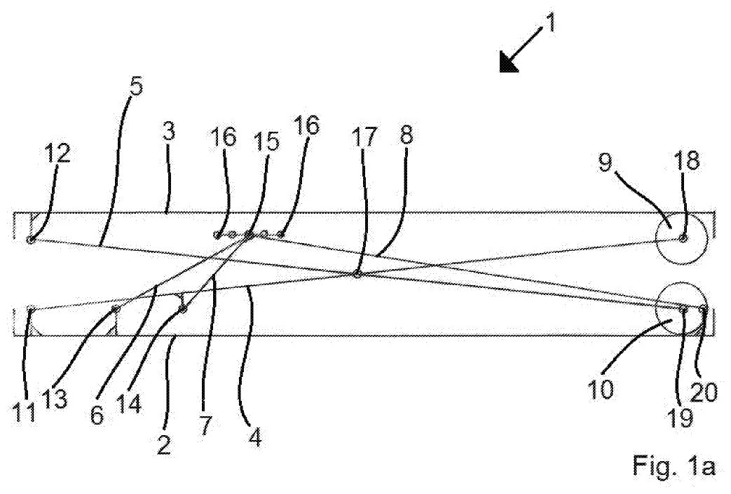

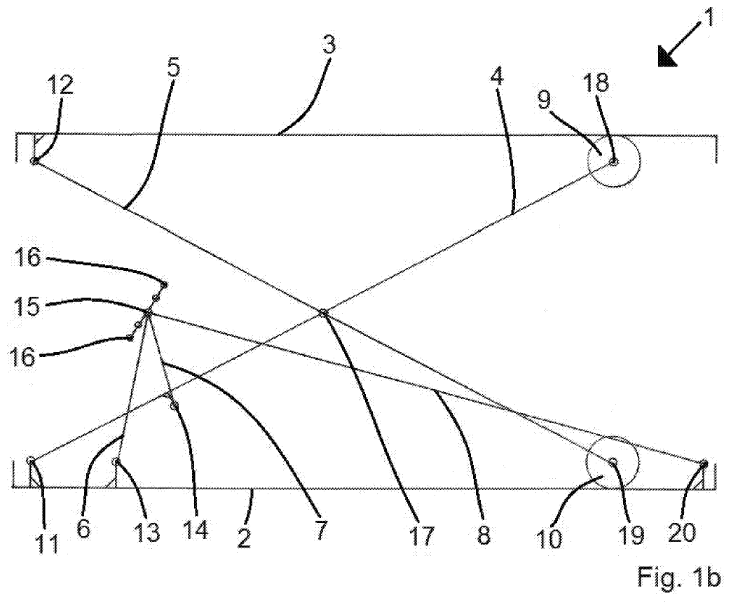

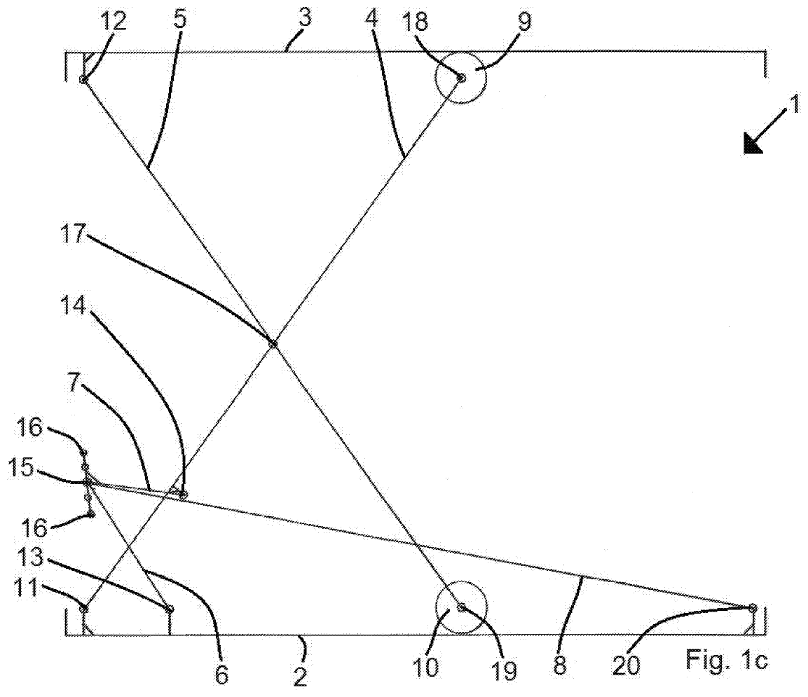

FIGS. 1a-1c are principle sketches of a scissor lift I according to an embodiment of the invention in a fully collapsed, in a partly unfolded and in a fully unfolded configuration, respectively.

A first lever arm 4 and a second lever arm 5, which are rotatably connected to each other in a pivotal point 17, forms a scissor configuration. In practice, there is such a scissor configuration in both sides of the scissor lift 1. For the sake of explanation, however, the following section explains the function of one such scissor configuration only.

When the scissor configuration, which constitutes a primary part of the lifting mechanism, is opened, two substantially parallel frames, namely a lower frame 2 and an upper frame 3, are forced away from each other. If the lower frame 2 is placed on a more or less horizontal surface, this means that the upper frame 3 (and whatever might be placed thereupon) is lifted when the scissor configuration is opened.

The first lever arm 4 is rotatably connected at its lowermost end to the lower frame 2 in a fulcrum 11 and in sliding engagement with the upper frame 3 at its uppermost end by means of a roller 9, which is suspended in a suspension point 18 on the first lever arm 4. Similarly, the second lever arm 5 is rotatably connected at its uppermost end to the upper frame 3 in a fulcrum 12 and in sliding engagement with the lower frame 2 at its lowermost end by means of a roller 10, which is suspended in a suspension point 19 on the second lever arm 5.

A controlling arm 6 is rotatably connected at its lowermost end to the lower frame 2 in a fulcrum 13 and rotatably connected at its uppermost end to a first end of a lifting arm 7 in a fulcrum 15, which lifting arm 7 at its other end is a rotatably connected to the first lever arm 4 in a fulcrum 14. A linear power source 8, such as a linear actuator, is rotatably connected to the lower frame 2 in a fulcrum 20 and rotatably connected to the controlling arm 6 and the lifting arm 7 in the fulcrum 15.

A lift of the upper frame 3 is performed by extending the length of the linear power source 8 and, thereby, the distance between the fulcrum 20 and the fulcrum 15, which forces fulcrum 15 and, thereby, the first end of the lifting arm 7 in a forward direction (towards the left side of the figures), since fulcrum 20 is fastened to the lower frame 3. Because the first end of the lifting arm 7 and the uppermost end of the controlling arm 6 are connected in the fulcrum 15 and the lowermost end of the controlling arm 6 is fastened in fulcrum 13 on the lower frame 2, extending the length of the power source 8 causes the fulcrum 15 and, thereby, the first end of the lifting arm 7 to follow a circular arc around the fulcrum 13. The other end of lifting arm 7 being connected to the first lever arm 4 in fulcrum 14, which at it lowermost end is connected to the lower frame 2 in fulcrum 11, this causes fulcrum 14 as well as suspension point 18 at the uppermost end of lever arm 4 to follow a circular arc around fulcrum 11. This, in turn, causes the upper frame 3 to be lifted, i.e. to be forced away from the lower frame 2, while the roller 9 rolls forward along the underside of upper frame 3.

The first lever arm 4 being rotatably connected to the second lever arm 5 in fulcrum 17 means that this rotation of the first lever arm 4 around fulcrum 11 causes fulcrum 17 to be moved in an upward direction, and the second lever arm 5 to perform a similar but oppositely directed rotation around fulcrum 12 and the roller 10 to roll forward along the upper side of lower frame 2. Thus, the distance between the lower frame 2 and the upper frame 3 is increased equally in both ends, i.e. in the full length of the upper frame 3, and the lower frame 2 and the upper frame 3 stay parallel to each other during the lift of the upper frame 3.

In FIGS. 1a-1c, a common fulcrum 15 is used for the controlling arm 6, the lifting arm 7 and the power source 8. It is schematically indicated in these figures how alternative fulcrums 16, which are displaced from the fulcrum 15, allow the lifting arm 7 and/or the power source 8 to be rotatably connected to the controlling arm 6 in different points. Using alternative fulcrums 16 for the lifting arm 7 and/or the power source 8 constitutes a simple way of adjusting the pulling angle of the lifting arm 7 or changing the power utilisation and stroke length of the power source 8 if so desired, for instance when replacing a power source 8 with another one with other technical characteristics.

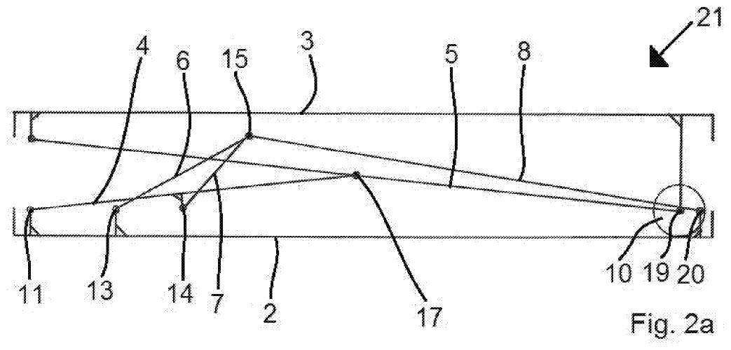

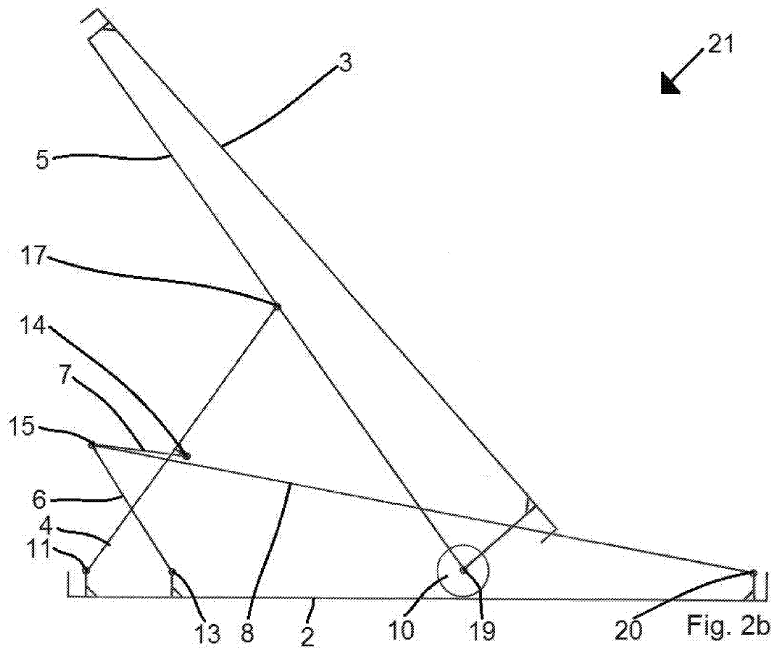

FIGS. 2a and 2b are principle sketches of a tilt system 21 according to an embodiment of the invention in an unfitted and in a fully tilted configuration, respectively. The mechanism of this tilt system 21 is very similar to the one of the scissor lift 1 described above, the only differences being that the upper part of the first lever arm 4 (above the fulcrum 17) has been removed and that the upper frame 3 is fastened to the second lever arm 5 at both ends thereof and, therefore, follows the rotation of the second lever arm 5,

Just as described above for the scissor lift 1, extending the length of the power source 8 causes the first lever arm 4 to rotate move the fulcrum 17 in an upward direction. This, in turn, causes the second lever arm 5 and, thereby, the upper frame 3 to rotate (or tilt) as illustrated in FIG. 2c.

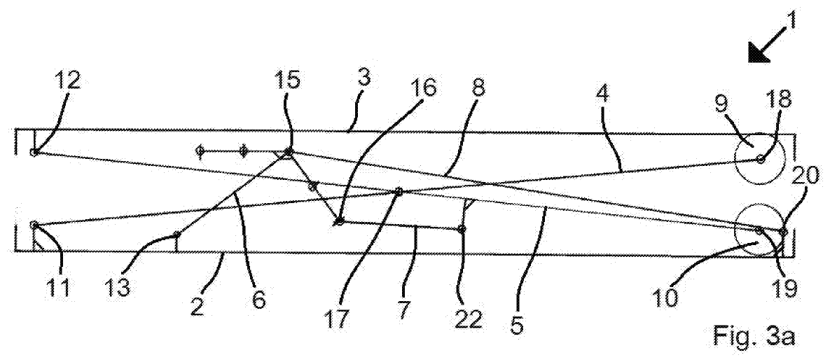

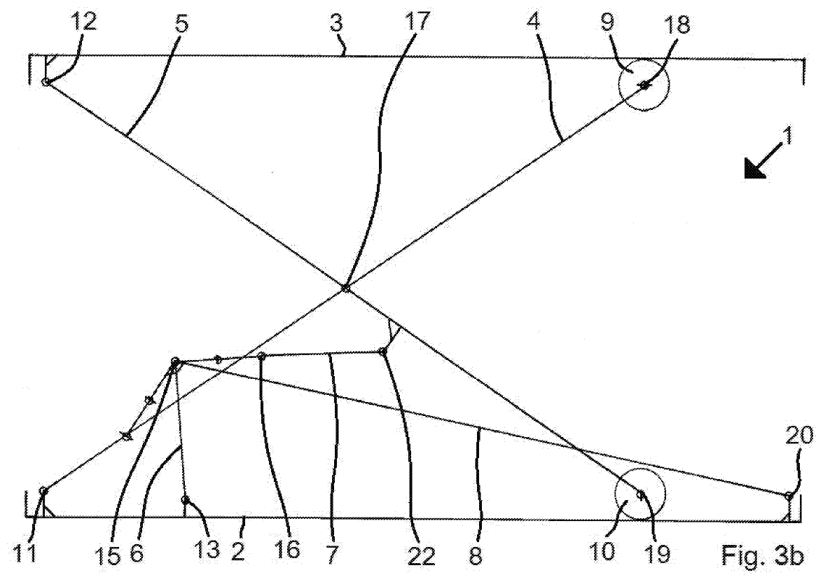

FIGS. 3a and 3b are principle sketches of a scissor lift 1 according to another embodiment of the invention in a fully collapsed and in a fully unfolded configuration, respectively.

The scissor lift 1 shown in FIGS. 3a and 3b is similar to the one shown in FIGS. 1a-1c in many ways but the lifting arm 7 is arranged in a different way: The first end of the lifting arm 7 is connected to one of the alternative fulcrums 16 instead of the fulcrum 15, and the second end of the lifting arm 7 is connected to a fulcrum 22 on the second lever arm 5 instead of the fulcrum 14 on the first lever arm 4.

### LIST OF REFERENCE NUMBERS

1. Scissor lift

2. Lower frame

3. Upper frame

4. First lever arm

5. Second lever arm

6. Controlling arm

7. Lifting arm

8. Power source

9. Roller or slider on first lever arm

10. Roller or slider on second lever arm

11. Fulcrum for first lever arm on lower frame

12. Fulcrum for second lever arm on upper frame

13. Fulcrum for controlling arm on lower frame

14. Fulcrum for lifting arm on first lever arm

15. Fulcrum for controlling arm and, potentially, lifting arm and/or power source

16. Alternative fulcrums for lifting arm and/or power source on controlling arm

17. Common fulcrum for first lever arm and second lever arm

18. Suspension point for roller or slider on first lever arm

19. Suspension point for roller or slider on second lever arm

20. Fulcrum for power source on lower frame

21. Tilt system

22. Fulcrum for lifting arm on first lever arm

1. A mechanism for a scissor lift (1) or for a tilt system (21), which mechanism comprises a lower frame (2) and an upper frame (3), which are connected by at least one pair of lever arms (4, 5) rotatably connected to each other in a pivotal point (17),
wherein, at least in a contracted configuration of the mechanism, the lower frame (2) and the upper frame (3) are substantially parallel to each other,
wherein a first lever arm (4) is rotatably connected at its lowermost end to the lower frame (2) in a fulcrum (11) and the second lever arm (5) is connected at its uppermost end to the upper frame (3) and in sliding engagement with the lower frame (2) at its lowermost end in such a way that, when the lowermost end of the second lever arm (5) is moved towards the lowermost end of the first lever arm (4), at least the end of the upper frame (3), to which the uppermost end of the second lever arm (5) is connected, is forced away from the lower frame (2), and
wherein the mechanism further comprises
a controlling arm (6) rotatably connected at its lowermost end to the lower frame (2) in a fulcrum (13) and rotatably connected at its uppermost end to a first end of a lifting arm (7) in a fulcrum (15; 16), which lifting arm (7) at its other end is a rotatably connected to the first lever arm (4) in a fulcrum (14) or to the second lever arm (5) in a fulcrum (22), and
a power source (8), such as a linear actuator, rotatably connected at its lowermost end to the lower frame (2) in a fulcrum (20) and rotatably connected at its uppermost end to the controlling arm (6) and/or the lifting arm (7) in a fulcrum (15; 16), in such a way that an extension of the length of the power source (8) causes the lifting arm (7) to pull the fulcrum (14) on the first lever arm (4) in a direction away from the lower frame (2), which, in turn, causes the lowermost end of the second lever arm (5) to be pulled towards the lowermost end of the first lever arm (4).

2. The mechanism according to claim 1 , wherein the controlling arm (6) and/or the lifting arm (7) is provided with a plurality of attachment points, potentially arranged on one or more flanges extending from the controlling arm (6) and/or the lifting arm (7), each of which attachment points can be used as fulcrums (15; 16) for connection of the uppermost end of the controlling arm (6), the first end of the lifting arm (7) and the uppermost end of the power source (8) to each other.

3. The mechanism according to claim 1 or 2, wherein the controlling arm (6), the lifting arm (7) and the power source (8) are all connected in a common fulcrum (15).

4. The mechanism according to claim 1 or 2, wherein the sliding engagement between the second lever arm and the lower frame is obtained by means of a roller or a slider (10) suspended in a suspension point (19) at the lowermost end of the second lever arm.

5. The mechanism according to claim 1 or 2, wherein the first lever arm (4) is in sliding engagement with the upper frame (3) at its uppermost end.

6. The mechanism according to claim 5, wherein the sliding engagement between the first lever arm and the upper frame is obtained by means of a roller or a slider (9) suspended in a suspension point (18) at the uppermost end of the first lever arm.

7. A scissor lift (1) comprising a mechanism according to claim 5.

8. The scissor lift (1) according to claim 7, wherein the scissor lift (1) is able to lift a load of at least 180 kg, preferably at least 250 kg.

9. The scissor lift (1) according to claim 7 or 8, wherein the scissor lift (1) is able to lift a load over a range of at least 250 mm, preferably at least 300 mm.

10. The scissor lift (1) according to claim 7 or 8, wherein the height of the scissor lift (1) in a fully collapsed configuration is less than 125 mm, preferably less than 90 mm.

11. A tilt system (21) comprising a mechanism according to claim 1.

12. The tilt system (21) according to claim 11, wherein the tilt system is able to tilt the upper frame (3) in an angle of at least 40°, preferably at least 60°, compared to the lower frame (2).

13. A wheel chair with a built-in seat hoist comprising a scissor lift (1) according to claim 7 or 8 and/or a tilt system (21) according to claim 11 or 12.
